(19) United States
(12) Patent Application Publication
(10) Pub. No.: US 2009/0300909 A1
(43) Pub. Date: Dec. 10, 2009

(54) LOW TEMPERATURE APPLICATIONS OF FLAME RETARDANT POWER CABLE

(75) Inventors: RANDY KUMMER, Villa Rica, GA (US); Patricia L. Bridges, Hiram, GA (US)

Correspondence Address: MERCHANT & GOULD KS, P.O. BOX 2903, MINNEAPOLIS, MN, 55402, US

(73) Assignee: Southwire Company, Carrollton, GA (US)

(21) Appl. No.: 12/478,913

(22) Filed: Jun. 5, 2009

Related U.S. Application Data
(60) Provisional application No. 61/060,220, filed on Jun. 10, 2008.

(51) Int. Cl. H01R 43/00

(52) U.S. Cl. 29/825

(57) ABSTRACT

Jacketed power cables may have a core conductor and an outermost layer of cable jacketing material that may be PVC-based or polyolefin-based, and that may contain a flame retardant additive. These jacketed power cables may have sufficient flame retardancy and cold impact strength to be installed and/or used at temperatures below 0° C.

### REFERENCE TO RELATED APPLICATION

This application claims the benefit of U.S. Provisional Application Ser. No. 61/060,220, filed on Jun. 10, 2008, the disclosure of which is incorporated herein by reference in its entirety.

### COPYRIGHTS

All rights, including copyrights, in the material included herein are vested in and the property of the Applicants. The Applicants retain and reserve all rights in the material included herein, and grant permission to reproduce the material only in connection with reproduction of the granted patent and for no other purpose.

### BACKGROUND

Electrical cables may be built with flame retardancy. In addition, electrical cables may have cold impact strength in order to be installed and used at low temperatures. Materials that may be employed to improve an electrical cable's flame retardant properties, however, may negatively impact the electrical cable's low temperature flexibility and impact properties.

### SUMMARY

This summary is provided to introduce a selection of concepts in a simplified form that are further described below in the detailed description. This summary is not intended to identify key features or essential features of the claimed subject matter. Nor is this summary intended to be used to limit the claimed subject matter's scope.

Embodiments of this invention may relate generally to power cables, cable jacketing material, flame retardant requirements, and the performance of jacketed cables in low temperature applications. Embodiments of the invention may be directed to flame retardant power cables that can be used at temperatures of about 0° C. and below, for example, about −25° C. and below, or about −40° C. and below.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1A shows a perspective view of a jacketed power cable; and

FIG. 1B shows a cross-sectional view of the jacketed power cable illustrated in FIG. 1A.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

The flame retardant performance of a cable can be determined from many different standardized tests depending upon, for example, the particular use or application of the cable. One such test may comprise the UL or Canadian Standards Association (CSA/UL) FT4 Vertical Flame Test. Test cables may be placed in cable trays as described in CSA C22.2 No. 2556-07 Section 9.6 Method 2, in a manner similar to that employed in the UL-1685 Vertical Tray Fire Propagation Test. In the FT4 Vertical Flame Test, the size of the cable determines how and how many of the cables are tied into a cable tray for testing. For instance, the FT4 samples larger than about 13 mm (about 0.5 inches) in diameter are tied individually. If the diameter of the cable is less than about 13 mm, then the cable samples may be grouped in units of at least three to obtain a grouped overall diameter of at least 13 mm.

The FT4 Vertical Flame Test can be conducted in accordance with the following general procedure. An 8-foot ladder containing the specified number of lengths of the cable to be tested, per the appropriate standard, may be secured vertically in a chamber. A burner may be mounted one foot from the floor at a 20° angle from horizontal, with the burner ports facing up, at a specified distance from the cables. The test cable may be burned at 70,000 BTU/hr for 20 minutes. To meet the FT4 criteria, the cable may not show any char or similar damage more than 1.5 meters above the lower edge of the burner face. Jacketed cables, consistent with embodiments of the present invention, may meet the criteria of the FT4 Vertical Flame Test.

The selection of jacketing material for cables may depend on numerous criteria that are often application dependent and include, but are not limited to, flame retardancy, insulation or conductive requirements, mechanical and impact strength, flexibility, chemical resistance and barrier properties, temperature and environmental conditions, aging and weatherability, material cost, and the like. Jacketing material can be based on various polymers, such as polyolefins, e.g., ethylene homopolymers and ethylene copolymers, including polyethylene, ethylene/alpha-olefin copolymers, ethylene polypropylene rubber (EPR), thermoset materials based on ethylene-propylene (EP) or ethylene-propylene-diene monomer (EPDM) copolymers, and the like. Halogen-containing polymers also can be used, and non-limiting examples of these include chlorinated polyethylene (CPE) and poly (vinyl chloride) (PVC). Consistent with embodiments of the invention, the cable jacketing material may comprise a polyolefin, such as a polyethylene or an ethylene copolymer, or a PVC, or a combination thereof.

In accordance with embodiments of the invention, a cable jacketing composition comprising a polyolefin may comprise at least one polyolefin resin (e.g., a polyethylene, an ethylene copolymer, etc.), at least one flame retardant, and at least one adhesive component. In such a composition, the polyolefin resin content may be in a range from about 25% to about 40% by weight. The flame retardant content may be in a range from about 40% to about 60% by weight. The adhesive component content may be in a range from about 2% to about 10% by weight. Other components may be present in a polyolefin-based cable jacketing composition and these can include, but are not limited to, antioxidants, lubricants, fillers, pigments, and the like, or combinations thereof.

In accordance with embodiments of the invention, a cable jacketing composition comprising a PVC may comprise at least one PVC resin, at least one flame retardant, and at least one plasticizer. In such a composition, the PVC resin content may be in a range from about 40% to about 60% by weight. The flame retardant content may be in a range from about 10% to about 25% by weight. The plasticizer content may be in a range from about 20% to about 40% by weight. Other components may be present in a PVC-based cable jacketing composition and these can include, but are not limited to, heat stabilizers, lubricants, fillers, pigments, and the like, or combinations thereof.

Flame retardancy can be accomplished by any suitable process. For instance, halogenated materials containing either chlorine or bromine can be employed. Non-halogen materials such as magnesium hydroxide, aluminum hydroxide, alumina trihydrate, antimony trioxide, and the like, also can be used as flame retardant additives. For instance, consistent with embodiments of the invention, at least one flame retardant additive may be used in the cable jacketing, and the at least one flame retardant additive may comprise magnesium hydroxide, aluminum trihydrate, antimony trioxide, or a combination thereof.

Antioxidants may be used in polyolefin cable jacketing compositions, and heat stabilizers may be used in PVC cable jacketing compositions. Antioxidants may be phenolic or phosphite compounds which may improve stability of the polyolefin during processing and/or long-term use. Likewise, heat stabilizers may improve the stability of PVC during processing and/or long-term use, and these may be either lead-based stabilizers or non-lead based stabilizers.

Lubricants such as stearates, fatty amides, stearic acid, and the like, can be additives in cable jacketing compositions.

Adhesive components may be present in a polyolefin formulation to improve the compatibility of the materials in the formulation. A maleic anhydride containing compound or polymer may be used as an adhesive component. PVC cable jacketing formulations or compositions may contain one or more plasticizers, and such plasticizers can be phthalate compounds, but are not limited thereto.

Other inorganic compounds, fillers, pigments, and the like, also may be present in the formulations and compositions disclosed herein. Calcium carbonate, kaolin clay, and carbon black may be non-limiting examples of these materials. The loading and type of these materials may depend on the end-use application of the cable.

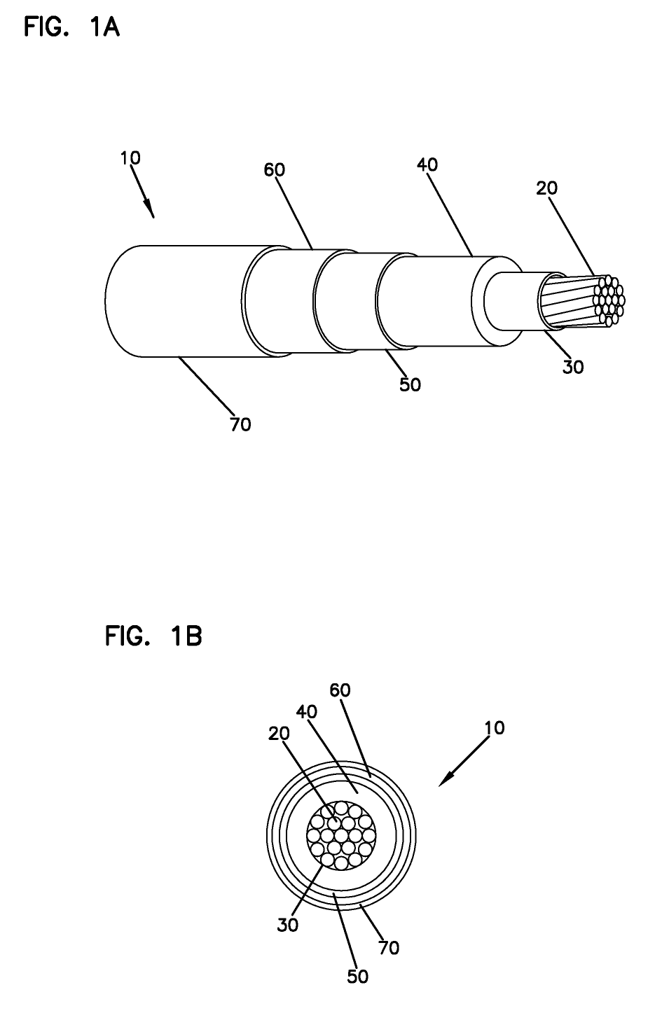

Embodiments of the invention are not limited to any particular power cables, systems, and markets. Contemplated herein are cables for low voltage, medium voltage, high voltage applications, and the like. For example, the jacketed power cable may comprise a medium voltage power cable. Cables consistent with embodiments of this invention may be FT4 rated, that is, the cables may meet the criteria for, or pass, the UL or CSA FT4 Vertical Flame Test. Such a medium voltage power cable 10 may be illustrated in FIGS. 1A-1B and may contain the following elements, from inside to out: core conductor 20 (e.g., copper), conductor shield 30 (e.g., semi-conducting thermoset), insulation 40 (e.g., EPR), insulation shield 50 (e.g., semi-conducting thermoset), copper tape shield 60, and cable jacketing material 70 (e.g., thermoplastic or thermoset cable jacketing composition). Jacketed power cables consistent with embodiments of the invention may comprise a core conductor and an outermost layer comprising a cable jacketing composition, for instance, a polyolefin or PVC cable jacketing composition. However, embodiments of the invention are not limited to the medium voltage power cable construction described above and illustrated in FIGS. 1A-1B.

Consistent with embodiments of the invention, the jacketed power cable may not include a layer of armor (a layer of a metallic armor such as steel or aluminum, for instance) in order to pass a UL or CSA FT4 Vertical Flame Test, to pass a UL or CSA cold impact test at −40° C., or both. Generally, when utilized, armor is positioned on the outside of the jacketed power cable or power cable assembly (i.e., outside the cable jacketing material 70 in FIGS. 1A-1B), and may be optionally covered with another layer of a jacketing material. Jacketed power cables in accordance with embodiments of this invention generally do not contain any metal layer outside the cable jacketing material (i.e., the conductor jacket).

Additionally, embodiments of the invention are not limited to wires or cables of any particular size. In the American wire gauge (AWG) system, decreasing gauge numbers may result in increasing wire diameters. For instance, wires and cables having an AWG less than 4, or a diameter greater than 0.2 inches may be used with embodiments of the present invention. Generally, conductors larger than about 1/0 AWG (i.e., “one aught”) may be used. For instance, wires or cables with sizes greater than about 150 kcmil, or greater than about 200 kcmil, can be employed. In the wire and cable industry, 1000 circular mil may be referred to as 1 MCM or 1 kcmil, and is equal to approximately 0.5 mm².

Flame retardant cables consistent with embodiments of the invention often may be used and/or installed in low temperature climates. A low temperature climate may be any environment where the average temperature over a 24-hr period is less than 0° C. The incorporation of additives to a polymer matrix, such as a flame retardant, can make the resultant material more brittle and less flexible at these low temperatures. Impact strength at low temperatures, for example, can be reduced significantly due to the presence of flame retardant additives that may be used to meet the criteria of the FT4 Vertical Flame Test. Plasticizers and the like can be employed to improve the low temperature flexibility and impact properties of cable jacketing material, however, these materials can negatively impact the flame retardant properties of the jacketed power cable.

Not only can the flame retardant cables consistent with embodiments of the invention be used and/or installed at temperatures that are less than 0° C., but they also can be used and/or installed at temperatures of −25° C. and below. Furthermore, the flame retardant cables can be used and/or installed at a temperature of between about 0° C. and about −25° C., between about −25° C. and about −40° C., between about −40° C. and about −45° C., or between about −40° C. and about −50° C. Cables consistent with embodiments of this invention may be installed overhead, installed underground, installed in conduit, etc. These cables may be used to transmit power continuously, or on a periodic or as-needed basis.

Fitness of the cables at these low temperatures may be determined using UL and CSA standards for cold temperature impact resistance, for example, UL 2556 section 7.6. The UL and CSA cold impact test procedure at −40° C. utilizes ten 5-inch samples of cable that are conditioned in a freezer controlled at −40° C. for four hours. After conditioning for four hours, the test specimens may be impacted with a 3-lb weight at a drop height of 3 feet. In order to pass the cold impact test at ″40° C., no more than two of the ten samples can show any cracks. In embodiments of the invention, FT4 rated medium voltage cable prepared using polyolefin-based or PVC-based jacketing compositions may pass the cold impact test at a temperature of −40° C.

Table I summarizes the CSA analytical test procedures for flame retardancy and low temperature impact strength.

TABLE I
Flame retardancy and low temperature impact test procedures.

| | | Minimum | Test | |
|---|---|---|---|---|
| Test | Units | Required | Material | Comments |
| Impact | Pass/ | Pass | Cable | No more than 2 of 10 |
| −40° C. | Fail | | | samples can fail |
| FT4 | Pass/ | Pass | Cable | Flame propagation |
| Flame Test | Fail | | | and char height |

Notes on Table I:
CAN-CSA-C68.3 provides the minimum requirements and test conditions for medium voltage cable.
CSA Standard C22.2 No. 0.3 and CSA Standard C22.2 No. 2556 provide analytical testing procedures.

In accordance with embodiments of the invention, the cables and jacketing compositions disclosed herein may be characterized as passing the FT4 flame test, or passing the −40° C. impact test, or both. Also, in accordance with embodiments of the invention, a method of transmitting power in a low temperature climate is provided, and this method may comprise installing a jacketed power cable in the low temperature climate, and using the jacketed power cable to transmit power.

### EXAMPLES

Embodiments of the invention may be further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the embodiments of the invention or the scope of the appended claims.

The cables of Example 1-6 were produced via extrusion or other suitable method for forming an outermost layer of a jacketing composition around a core conductor and other intermediate layers (i.e., the exact cable structure may be application dependent). See, for instance, FIGS. 1A-1B. The jacketing composition for Examples 1-5 was PVC-based, and the jacketing composition for Example 6 was polyolefin-based.

The PVC-based compositions contained, by weight, about 40% to about 60% PVC, about 10% to about 25% flame retardant and fillers, about 20% to about 40% plasticizer, and about 1% to about 5% heat stabilizer plus lubricant.

The polyolefin-based composition contained, by weight, about 25% to about 45% polyolefin resin, about 40% to about 60% flame retardant, about 2% to about 10% adhesive component, and a small amount of antioxidant(s). The polyolefin grade used was 1638, available from the Dow Chemical Company.

Each respective jacketing composition was prepared by mixing or blending the various components using a suitable method. Table II presents flame retardancy and cold impact analytical results for Examples 1-6, tested in accordance with CSA standards.

TABLE II
Flame retardancy and cold impact testing summary for Examples 1-6.

| | Example | | | | | |
|---|---|---|---|---|---|---|
| | 1 | 2 | 3 | 4 | 5 | 6 |
| Impact | Fail | Pass | Fail | Pass | Pass | Pass |
| −40° C. | | | | | | |
| FT-4 | Pass | Pass | Pass | Pass | Pass | Pass |
| Flame Test | | | | | | |

What is claimed is:

1. A method of transmitting power in a low temperature climate, the method comprising:
installing a jacketed power cable in the low temperature climate; and
using the jacketed power cable to transmit power;
wherein the jacketed power cable passes a UL or CSA FT4 Vertical Flame Test and passes a UL or CSA cold impact test at −40° C., and
wherein the jacketed power cable does not contain a layer of armor.

2. The method of claim 1, wherein a temperature in the low temperature climate is in a range from about 0° C. and about −25° C.

3. The method of claim 1, wherein a temperature in the low temperature climate is in a range from about −25° C. and about −40° C.

4. The method of claim 1, wherein installing the jacketed power cable comprises one of the following: installing overhead, installing underground, and installing in conduit.

5. The method of claim 1, wherein the jacketed power cable comprises a core conductor and an outermost layer of cable jacketing material, and wherein the cable jacketing material comprises at least one polyolefin, at least one PVC, or a combination thereof.

6. The method of claim 5, wherein the cable jacketing material further comprises at least one flame retardant additive.

7. The method of claim 6, wherein the at least one flame retardant additive comprises magnesium hydroxide, aluminum trihydrate, antimony trioxide, or a combination thereof.

8. The method of claim 1, wherein the jacketed power cable is a medium voltage power cable.

9. A method of transmitting power in a low temperature climate, the method comprising:
installing a jacketed power cable in the low temperature climate; and
using the jacketed power cable to transmit power;
wherein the jacketed power cable passes a UL or CSA cold impact test at −40° C., and
wherein the jacketed power cable does not contain a layer of armor.

10. The method of claim 9, wherein a temperature in the low temperature climate is in a range from about 0° C. and about −25° C.

11. The method of claim 9, wherein a temperature in the low temperature climate is in a range from about −25° C. and about −40° C.

12. The method of claim 9, wherein installing the jacketed power cable comprises one of the following: installing overhead, installing underground, and installing in conduit.

13. The method of claim 9, wherein the jacketed power cable comprises a core conductor and an outermost layer of cable jacketing material, and wherein the cable jacketing material comprises at least one polyolefin, at least one PVC, or a combination thereof.

14. The method of claim 13, wherein the cable jacketing material further comprises at least one flame retardant additive.

15. The method of claim 14, wherein the at least one flame retardant additive comprises magnesium hydroxide, aluminum trihydrate, antimony trioxide, or a combination thereof.

16. The method of claim 9, wherein the jacketed power cable is a medium voltage power cable.

17. A method of transmitting power in a low temperature climate, the method comprising:
installing a jacketed power cable in the low temperature climate; and
using the jacketed power cable to transmit power;
wherein the jacketed power cable passes a UL or CSA FT4 Vertical Flame Test, and
wherein the jacketed power cable does not contain a layer of armor.

18. The method of claim 17, wherein installing the jacketed power cable comprises one of the following: installing overhead, installing underground, and installing in conduit.

19. The method of claim 17, wherein the jacketed power cable comprises a core conductor and an outermost layer of cable jacketing material, and wherein the cable jacketing material comprises at least one polyolefin, at least one PVC, or a combination thereof.

20. The method of claim 17, wherein the jacketed power cable is a medium voltage power cable.
